(19) United States
(12) Patent Application Publication
(10) Pub. No.: US 2013/0035918 A1
(43) Pub. Date: Feb. 7, 2013

(54) MULTI-GRID FLUID PRESSURE SOLVER HANDLING SEPARATING SOLID BOUNDARY CONDITIONS

(71) Applicants: Nuttapong Chentanez, Bangkok (TH); Matthias Müller-Fischer, Stafa (CH)

(72) Inventors: Nuttapong Chentanez, Bangkok (TH); Matthias Müller-Fischer, Stafa (CH)

(21) Appl. No.: 13/562,156

(22) Filed: Jul. 30, 2012

Related U.S. Application Data
(60) Provisional application No. 61/515,276, filed on Aug. 4, 2011.

(51) Int. Cl. G06G 7/57

(52) U.S. Cl. 703/9

(57) ABSTRACT

One embodiment of the present invention sets forth a geometric multi-grid technique which enables accurate simulations of three dimensional (3D) fluid volumes. A model of the fluid to be simulated is represented using a cubic cell grid. The geometric multi-grid is generated to provide a hierarchy of increasingly coarser representations of the model that are used by a fluid pressure solver. During fluid simulations, the linear complementarity problem (LCP) resulting from discretizing the Poisson equation, subject to separating solid boundary conditions, is solved using the geometric multi-grid. Visual artifacts such as liquid sticking to a bounding surface are minimized and the computations performed to solve the LCP are simplified.

### CROSS-REFERENCE TO RELATED APPLICATIONS

This application claims benefit of U.S. provisional patent application Ser. No. 61/515,276 (Attorney Docket No. NVDA/SC-11-0144-US0) filed Aug. 4, 2011, and titled “A MULTI-GRID FLUID PRESSURE SOLVER HANDLING SEPARATING SOLID BOUNDARY CONDITIONS.” The subject material of this related application is hereby incorporated herein by reference.

### FIELD OF THE INVENTION

The present invention generally relates to fluid simulation and more specifically to a multi-grid fluid pressure solver handling solid boundary conditions.

### DESCRIPTION OF THE RELATED ART

For many years, liquid simulation has been successfully used in computer graphics to generate visual effects. However, the computations required to produce realistic images are complex, so visual artifacts are sometimes produced when simpler computations are used. A visual artifact encountered by researchers and practitioners is liquid that appears to crawl on walls and stick to surfaces, such as ceilings. The artifact is caused by the fact that standard linear solvers restrict the normal velocity of the liquid at the solid boundary (such as a ceiling) to be zero. Normal velocity refers to the component of the relative liquid velocity in the direction normal to the solid surface away from the solid at the solid boundary.

In nature, the phenomenon of liquids having zero normal velocity at solid boundaries is indeed observed in which case the liquid forms a thin film on walls and ceilings. Thus, simply restricting the normal velocity of the liquid to zero at the solid boundary during a simulation is not incorrect. However, in conventional grid-based simulations, the thickness of the region influenced by the zero normal velocity at boundaries is of the order of the grid spacing. Visual artifacts are produced because the grid spacing used in practical scenarios is usually much larger than the thickness of the thin liquid film found in nature. Fluid simulations are performed by solving the Poisson equation. Allowing non-zero values for normal velocity is one possible technique for reducing the occurrence of the visual artifacts.

Allowing non-zero values of normal velocity for the liquid converts the linear system of the discretized Poisson equation into a Linear Complementarity Problem (LCP) which is much more difficult to solve. Therefore, researchers in computer graphics have tolerated the visual artifacts associated with restricting the normal velocity values to avoid solving a LOP.

Accordingly, what is needed in the art is fluid simulation technique that reduces the incidence of visual artifacts and is computationally simpler than solving an LCP using conventional techniques.

### SUMMARY OF THE INVENTION

One embodiment of the present invention sets forth a system and method for multi-grid fluid pressure solver handling solid boundary conditions. The method includes obtaining a geometric multi-grid representing a three-dimensional model of a fluid volume, where the geometric multi-grid comprises first level-set field values associated with a first three-dimensional grid of regular cubic cells and second level-set field values associated with a second three-dimensional grid of regular cubic cells that are coarser than the first three-dimensional grid of regular cubic cells. A separating complementarity condition is applied to constrain pressure values for the first three-dimensional grid. The pressure values from the first level of the geometric multi-grid are propagated to a coarsest level of the geometric multi-grid to produce downsampled pressure values. The downsampled pressure values are propagated from the coarsest level of the geometric multi-grid to the first level of the multi-grid to produce updated pressure values. A frame of data corresponding to the three-dimensional model of the fluid volume is generated based on the updated pressure values and the downsampled pressure values.

One advantage of the disclosed technique is that fluid simulations having solid boundary conditions may be performed with fewer visual artifacts and using a technique that is computationally simpler than a conventional LCP solution.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing subsystem for the computer system of FIG. 1, according to one embodiment of the present invention;

FIG. 3A is a block diagram of a GPC within one of the PPUs of FIG. 2, according to one embodiment of the present invention;

FIG. 3B is a block diagram of a partition unit within one of the PPUs of FIG. 2, according to one embodiment of the present invention;

FIG. 3C is a block diagram of a portion of the SPM of FIG. 3A, according to one embodiment of the present invention;

FIG. 4 is a conceptual diagram of a graphics processing pipeline that one or more of the PPUs of FIG. 2B can be configured to implement, according to one embodiment of the present invention;

FIG. 5A is an image of an initial condition of water in a sphere;

FIG. 5B is an image of water in a sphere produced using conventional standard solid boundary condition simulation techniques, according to the prior art;

FIG. 5C is an image of water in a sphere produced using separating boundary condition simulation techniques, according to one embodiment of the present invention;

FIG. 5D is a cross section of the geometric cell grid model, according to one embodiment of the present invention;

FIGS. 5E and 5F illustrate coarser hierarchical levels of the multi-grid for the geometric cell grid shown in FIG. 5D, according to one embodiment of the present invention;

FIG. 6 is a flow diagram illustrating a technique for performing a simulation that applies separating boundary conditions to a multi-grid model of a fluid volume, according to one embodiment of the present invention;

FIG. 7 a technique for constructing a multi-grid for use by a multi-grid fluid pressure solver, according to one embodiment of the present invention;

FIG. 8A is an image of an initial condition of liquid in a circle that is moving diagonally to the right and upwards, where the circle provides a solid boundary;

FIG. 8B is an image of the liquid in the circuit produced using conventional solid boundary condition simulation techniques, according to the prior art;

FIG. 8C is an image of liquid in a circle produced using separating boundary condition simulation techniques with the separating boundary conditions are enforced at the center of cubic cells, according to one embodiment of the present invention; and

FIG. 8D is an image of liquid in a circle produced using separating boundary condition simulation techniques with the separating boundary conditions are enforced at the interface, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

### System Overview

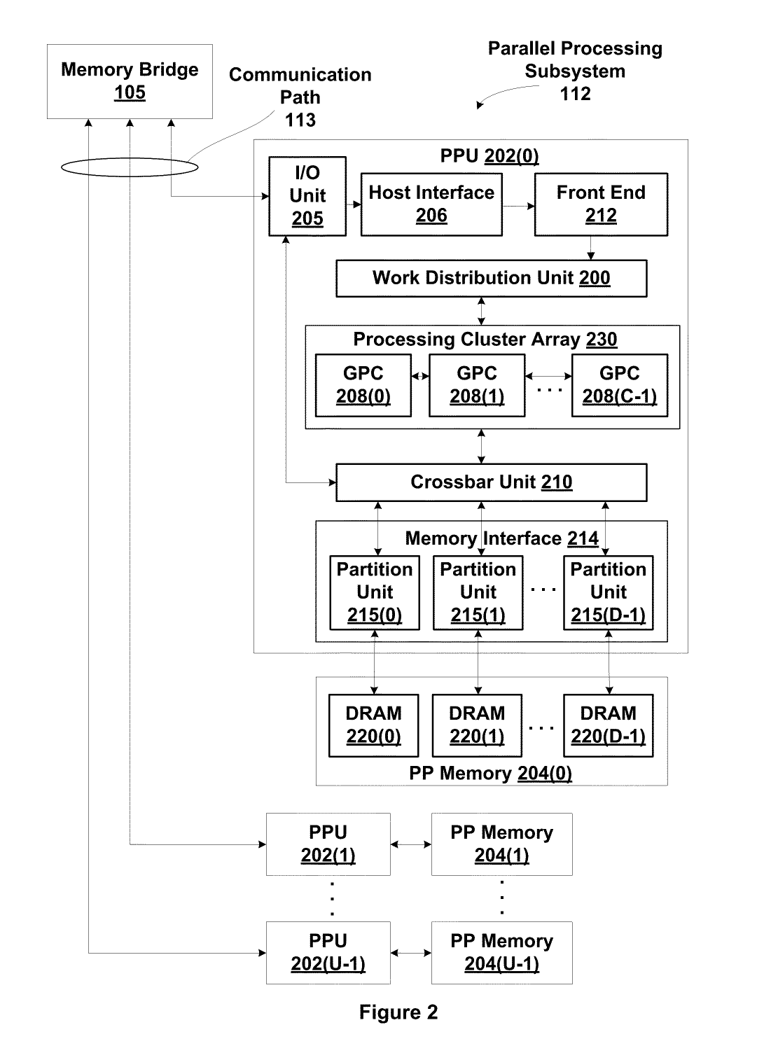

FIG. 2A is a block diagram illustrating a computer system 100 configured to implement one or more aspects of the present invention. Computer system 100 includes a central processing unit (CPU) 102 and a system memory 104 communicating via an interconnection path that may include a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via path 106 and memory bridge 105. A parallel processing subsystem 112 is coupled to memory bridge 105 via a bus or other communication path 113 (e.g., a PCI Express, Accelerated Graphics Port, or HyperTransport link); in one embodiment parallel processing subsystem 112 is a graphics subsystem that delivers pixels to a display device 110 (e.g., a conventional CRT or LCD based monitor). A system disk 114 is also connected to I/O bridge 107. A switch 116 provides connections between I/O bridge 107 and other components such as a network adapter 118 and various add-in cards 120 and 121. Other components (not explicitly shown), including USB or other port connections, CD drives, DVD drives, film recording devices, and the like, may also be connected to I/O bridge 107. Communication paths interconnecting the various components in FIG. 2A may be implemented using any suitable protocols, such as PCI (Peripheral Component Interconnect), PCI-Express, AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements, such as the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip. Large embodiments may include two or more CPUs 102 and two or more parallel processing systems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

FIG. 2B illustrates a parallel processing subsystem 112, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U□1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), or memory devices, or in any other technically feasible fashion.

Referring again to FIG. 2A, in some embodiments, some or all of PPUs 202 in parallel processing subsystem 112 are graphics processors with rendering pipelines that can be configured to perform various tasks related to generating pixel data from graphics data supplied by CPU 102 and/or system memory 104 via memory bridge 105 and bus 113, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations. The PPUs may be identical or different, and each PPU may have its own dedicated parallel processing memory device(s) or no dedicated parallel processing memory device(s). One or more PPUs 202 may output data to display device 110 or each PPU 202 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a pushbuffer (not explicitly shown in either FIG. 2A or FIG. 2B) that may be located in system memory 104, parallel processing memory 204, or another storage location accessible to both CPU 102 and PPU 202. PPU 202 reads the command stream from the pushbuffer and then executes commands asynchronously relative to the operation of CPU 102.

Referring back now to FIG. 2B, each PPU 202 includes an I/O (input/output) unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/O bridge 107. In still other embodiments, some or all elements of PPU 202 may be integrated on a single chip with CPU 102.

In one embodiment, communication path 113 is a PCI-EXPRESS link, in which dedicated lanes are allocated to each PPU 202, as is known in the art. Other communication paths may also be used. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each pushbuffer and outputs the work specified by the pushbuffer to a front end 212.

Each PPU 202 advantageously implements a highly parallel processing architecture. As shown in detail, PPU 202(0) includes a processing cluster array 230 that includes a number C of general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. For example, in a graphics application, a first set of GPCs 208 may be allocated to perform patch tessellation operations and to produce primitive topologies for patches, and a second set of GPCs 208 may be allocated to perform tessellation shading to evaluate patch parameters for the primitive topologies and to determine vertex positions and other per-vertex attributes. The allocation of GPCs 208 may vary dependent on the workload arising for each type of program or computation.

GPCs 208 receive processing tasks to be executed via a work distribution unit 200, which receives commands defining processing tasks from front end unit 212. Processing tasks include indices of data to be processed, e.g., surface (patch) data, primitive data, vertex data, and/or pixel data, as well as state parameters and commands defining how the data is to be processed (e.g., what program is to be executed). Work distribution unit 200 may be configured to fetch the indices corresponding to the tasks, or work distribution unit 200 may receive the indices from front end 212. Front end 212 ensures that GPCs 208 are configured to a valid state before the processing specified by the pushbuffers is initiated.

When PPU 202 is used for graphics processing, for example, the processing workload for each patch is divided into approximately equal sized tasks to enable distribution of the tessellation processing to multiple GPCs 208. A work distribution unit 200 may be configured to produce tasks at a frequency capable of providing tasks to multiple GPCs 208 for processing. By contrast, in conventional systems, processing is typically performed by a single processing engine, while the other processing engines remain idle, waiting for the single processing engine to complete its tasks before beginning their processing tasks. In some embodiments of the present invention, portions of GPCs 208 are configured to perform different types of processing. For example a first portion may be configured to perform vertex shading and topology generation, a second portion may be configured to perform tessellation and geometry shading, and a third portion may be configured to perform pixel shading in pixel space to produce a rendered image. Intermediate data produced by GPCs 208 may be stored in buffers to allow the intermediate data to be transmitted between GPCs 208 for further processing.

Memory interface 214 includes a number D of partition units 215 that are each directly coupled to a portion of parallel processing memory 204, where D≧1. As shown, the number of partition units 215 generally equals the number of DRAM 220. In other embodiments, the number of partition units 215 may not equal the number of memory devices. Persons skilled in the art will appreciate that DRAM 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Any one of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the embodiment shown in FIG. 2B, crossbar unit 210 is directly connected with I/O unit 205. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory exclusively or almost exclusively. In UMA embodiments, a PPU 202 may be integrated into a bridge chip or processor chip or provided as a discrete chip with a high-speed link (e.g., PCI-EXPRESS) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

### Processing Cluster Array Overview

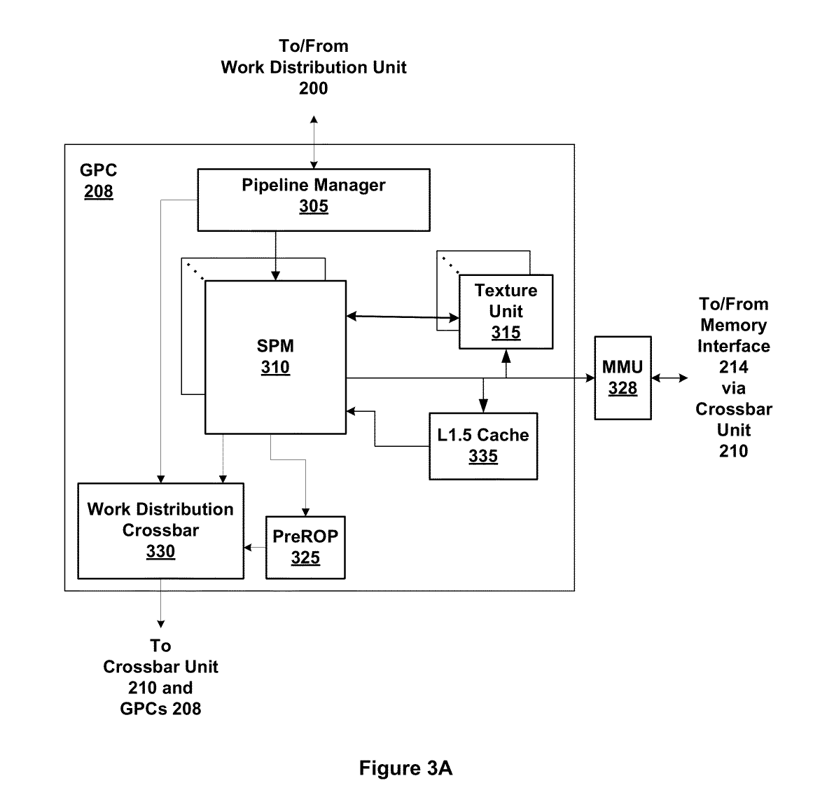

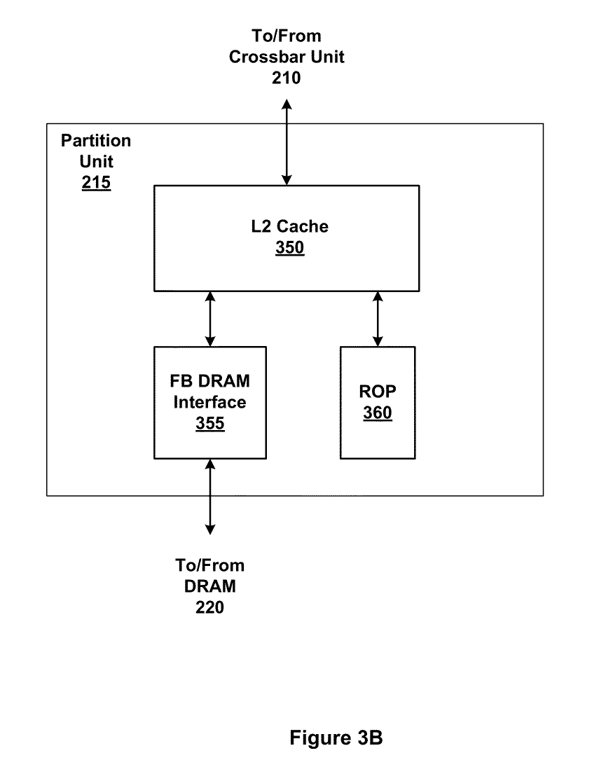

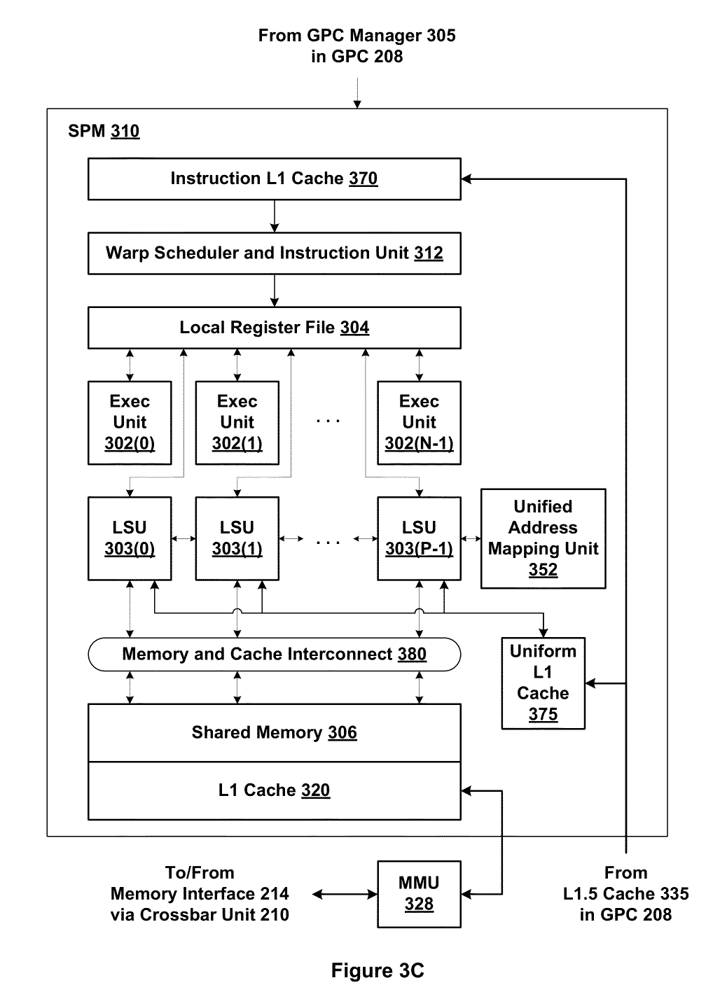

FIG. 3A is a block diagram of a GPC 208 within one of the PPUs 202 of FIG. 2B, according to one embodiment of the present invention. Each GPC 208 may be configured to execute a large number of threads in parallel, where the term “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within each one of the GPCs 208. Unlike a SIMD execution regime, where all processing engines typically execute identical instructions, SIMT execution allows different threads to more readily follow divergent execution paths through a given thread program. Persons skilled in the art will understand that a SIMD processing regime represents a functional subset of a SIMT processing regime.

Operation of GPC 208 is advantageously controlled via a pipeline manager 305 that distributes processing tasks to streaming multiprocessors (SPMs) 310. Pipeline manager 305 may also be configured to control a work distribution crossbar 330 by specifying destinations for processed data output by SPMs 310.

In one embodiment, each GPC 208 includes a number M of SPMs 310, where M≧1, each SPM 310 configured to process one or more thread groups. Also, each SPM 310 advantageously includes an identical set of functional execution units (e.g., execution units and load-store units—shown as Exec units 302 and LSUs 303 in FIG. 3C) that may be pipelined, allowing a new instruction to be issued before a previous instruction has finished, as is known in the art. Any combination of functional execution units may be provided. In one embodiment, the functional units support a variety of operations including integer and floating point arithmetic (e.g., addition and multiplication), comparison operations, Boolean operations (AND, OR, XOR), bit-shifting, and computation of various algebraic functions (e.g., planar interpolation, trigonometric, exponential, and logarithmic functions, etc.); and the same functional-unit hardware can be leveraged to perform different operations.

The series of instructions transmitted to a particular GPC 208 constitutes a thread, as previously defined herein, and the collection of a certain number of concurrently executing threads across the parallel processing engines (not shown) within an SPM 310 is referred to herein as a “warp” or “thread group.” As used herein, a “thread group” refers to a group of threads concurrently executing the same program on different input data, with one thread of the group being assigned to a different processing engine within an SPM 310. A thread group may include fewer threads than the number of processing engines within the SPM 310, in which case some processing engines will be idle during cycles when that thread group is being processed. A thread group may also include more threads than the number of processing engines within the SPM 310, in which case processing will take place over consecutive clock cycles. Since each SPM 310 can support up to G thread groups concurrently, it follows that up to G*M thread groups can be executing in GPC 208 at any given time.

Additionally, a plurality of related thread groups may be active (in different phases of execution) at the same time within an SPM 310. This collection of thread groups is referred to herein as a “cooperative thread array” (“CTA”) or “thread array.” The size of a particular CTA is equal to m*k, where k is the number of concurrently executing threads in a thread group and is typically an integer multiple of the number of parallel processing engines within the SPM 310, and m is the number of thread groups simultaneously active within the SPM 310. The size of a CTA is generally determined by the programmer and the amount of hardware resources, such as memory or registers, available to the CTA.

Each SPM 310 contains an L1 cache (not shown) or uses space in a corresponding L1 cache outside of the SPM 310 that is used to perform load and store operations. Each SPM 310 also has access to L2 caches within the partition units 215 that are shared among all GPCs 208 and may be used to transfer data between threads. Finally, SPMs 310 also have access to off-chip “global” memory, which can include, e.g., parallel processing memory 204 and/or system memory 104. It is to be understood that any memory external to PPU 202 may be used as global memory. Additionally, an L1.5 cache 335 may be included within the GPC 208, configured to receive and hold data fetched from memory via memory interface 214 requested by SPM 310, including instructions, uniform data, and constant data, and provide the requested data to SPM 310. Embodiments having multiple SPMs 310 in GPC 208 beneficially share common instructions and data cached in L1.5 cache 335.

Each GPC 208 may include a memory management unit (MMU) 328 that is configured to map virtual addresses into physical addresses. In other embodiments, MMU(s) 328 may reside within the memory interface 214. The MMU 328 includes a set of page table entries (PTEs) used to map a virtual address to a physical address of a tile and optionally a cache line index. The MMU 328 may include address translation lookaside buffers (TLB) or caches which may reside within multiprocessor SPM 310 or the L1 cache or GPC 208. The physical address is processed to distribute surface data access locality to allow efficient request interleaving among partition units. The cache line index may be used to determine whether of not a request for a cache line is a hit or miss.

In graphics and computing applications, a GPC 208 may be configured such that each SPM 310 is coupled to a texture unit 315 for performing texture mapping operations, e.g., determining texture sample positions, reading texture data, and filtering the texture data. Texture data is read from an internal texture L1 cache (not shown) or in some embodiments from the L1 cache within SPM 310 and is fetched from an L2 cache, parallel processing memory 204, or system memory 104, as needed. Each SPM 310 outputs processed tasks to work distribution crossbar 330 in order to provide the processed task to another GPC 208 for further processing or to store the processed task in an L2 cache, parallel processing memory 204, or system memory 104 via crossbar unit 210. A preROP (pre-raster operations) 325 is configured to receive data from SPM 310, direct data to ROP units within partition units 215, and perform optimizations for color blending, organize pixel color data, and perform address translations.

It will be appreciated that the core architecture described herein is illustrative and that variations and modifications are possible. Any number of processing units, e.g., SPMs 310 or texture units 315, preROPs 325 may be included within a GPC 208. Further, while only one GPC 208 is shown, a PPU 202 may include any number of GPCs 208 that are advantageously functionally similar to one another so that execution behavior does not depend on which GPC 208 receives a particular processing task. Further, each GPC 208 advantageously operates independently of other GPCs 208 using separate and distinct processing units, L1 caches, and so on.

FIG. 3B is a block diagram of a partition unit 215 within one of the PPUs 202 of FIG. 2B, according to one embodiment of the present invention. As shown, partition unit 215 includes a L2 cache 350, a frame buffer (FB) DRAM interface 355, and a raster operations unit (ROP) 360. L2 cache 350 is a read/write cache that is configured to perform load and store operations received from crossbar unit 210 and ROP 360. Read misses and urgent writeback requests are output by L2 cache 350 to FB DRAM interface 355 for processing. Dirty updates are also sent to FB 355 for opportunistic processing. FB 355 interfaces directly with DRAM 220, outputting read and write requests and receiving data read from DRAM 220.

In graphics applications, ROP 360 is a processing unit that performs raster operations, such as stencil, z test, blending, and the like, and outputs pixel data as processed graphics data for storage in graphics memory. In some embodiments of the present invention, ROP 360 is included within each GPC 208 instead of partition unit 215, and pixel read and write requests are transmitted over crossbar unit 210 instead of pixel fragment data.

The processed graphics data may be displayed on display device 110 or routed for further processing by CPU 102 or by one of the processing entities within parallel processing subsystem 112. Each partition unit 215 includes a ROP 360 in order to distribute processing of the raster operations. In some embodiments, ROP 360 may be configured to compress z or color data that is written to memory and decompress z or color data that is read from memory.

Persons skilled in the art will understand that the architecture described in FIGS. 2A, 2B, 3A, and 3B in no way limits the scope of the present invention and that the techniques taught herein may be implemented on any properly configured processing unit, including, without limitation, one or more CPUs, one or more multi-core CPUs, one or more PPUs 202, one or more GPCs 208, one or more graphics or special purpose processing units, or the like, without departing the scope of the present invention.

In embodiments of the present invention, it is desirable to use PPU 202 or other processor(s) of a computing system to execute general-purpose computations using thread arrays. Each thread in the thread array is assigned a unique thread identifier (“thread ID”) that is accessible to the thread during its execution. The thread ID, which can be defined as a one-dimensional or multi-dimensional numerical value controls various aspects of the thread's processing behavior. For instance, a thread ID may be used to determine which portion of the input data set a thread is to process and/or to determine which portion of an output data set a thread is to produce or write.

A sequence of per-thread instructions may include at least one instruction that defines a cooperative behavior between the representative thread and one or more other threads of the thread array. For example, the sequence of per-thread instructions might include an instruction to suspend execution of operations for the representative thread at a particular point in the sequence until such time as one or more of the other threads reach that particular point, an instruction for the representative thread to store data in a shared memory to which one or more of the other threads have access, an instruction for the representative thread to atomically read and update data stored in a shared memory to which one or more of the other threads have access based on their thread IDs, or the like. The CTA program can also include an instruction to compute an address in the shared memory from which data is to be read, with the address being a function of thread ID. By defining suitable functions and providing synchronization techniques, data can be written to a given location in shared memory by one thread of a CTA and read from that location by a different thread of the same CTA in a predictable manner. Consequently, any desired pattern of data sharing among threads can be supported, and any thread in a CTA can share data with any other thread in the same CTA. The extent, if any, of data sharing among threads of a CTA is determined by the CTA program; thus, it is to be understood that in a particular application that uses CTAs, the threads of a CTA might or might not actually share data with each other, depending on the CTA program, and the terms “CIA” and “thread array” are used synonymously herein.

FIG. 3C is a block diagram of the SPM 310 of FIG. 3A, according to one embodiment of the present invention. The SPM 310 includes an instruction L1 cache 370 that is configured to receive instructions and constants from memory via L1.5 cache 335. A warp scheduler and instruction unit 312 receives instructions and constants from the instruction L1 cache 370 and controls local register file 304 and SPM 310 functional units according to the instructions and constants. The SPM 310 functional units include N exec (execution or processing) units 302 and P load-store units (LSU) 303.

SPM 310 provides on-chip (internal) data storage with different levels of accessibility. Special registers (not shown) are readable but not writeable by LSU 303 and are used to store parameters defining each CTA thread's “position.” In one embodiment, special registers include one register per CTA thread (or per exec unit 302 within SPM 310) that stores a thread ID; each thread ID register is accessible only by a respective one of the exec unit 302. Special registers may also include additional registers, readable by all CTA threads (or by all LSUs 303) that store a CTA identifier, the CTA dimensions, the dimensions of a grid to which the CTA belongs, and an identifier of a grid to which the CTA belongs. Special registers are written during initialization in response to commands received via front end 212 from device driver 103 and do not change during CTA execution.

A parameter memory (not shown) stores runtime parameters (constants) that can be read but not written by any CTA thread (or any LSU 303). In one embodiment, device driver 103 provides parameters to the parameter memory before directing SPM 310 to begin execution of a CTA that uses these parameters. Any CTA thread within any CTA (or any exec unit 302 within SPM 310) can access global memory through a memory interface 214. Portions of global memory may be stored in the L1 cache 320.

Local register file 304 is used by each CTA thread as scratch space; each register is allocated for the exclusive use of one thread, and data in any of local register file 304 is accessible only to the CTA thread to which it is allocated. Local register file 304 can be implemented as a register file that is physically or logically divided into P lanes, each having some number of entries (where each entry might store, e.g., a 32-bit word). One lane is assigned to each of the N exec units 302 and P load-store units LSU 303, and corresponding entries in different lanes can be populated with data for different threads executing the same program to facilitate SIMD execution. Different portions of the lanes can be allocated to different ones of the G concurrent thread groups, so that a given entry in the local register file 304 is accessible only to a particular thread. In one embodiment, certain entries within the local register file 304 are reserved for storing thread identifiers, implementing one of the special registers.

Shared memory 306 is accessible to all CTA threads (within a single CTA); any location in shared memory 306 is accessible to any CTA thread within the same CTA (or to any processing engine within SPM 310). Shared memory 306 can be implemented as a shared register file or shared on-chip cache memory with an interconnect that allows any processing engine to read from or write to any location in the shared memory. In other embodiments, shared state space might map onto a per-CTA region of off-chip memory, and be cached in L1 cache 320. The parameter memory can be implemented as a designated section within the same shared register file or shared cache memory that implements shared memory 306, or as a separate shared register file or on-chip cache memory to which the LSUs 303 have read-only access. In one embodiment, the area that implements the parameter memory is also used to store the CTA ID and grid ID, as well as CTA and grid dimensions, implementing portions of the special registers. Each LSU 303 in SPM 310 is coupled to a unified address mapping unit 352 that converts an address provided for load and store instructions that are specified in a unified memory space into an address in each distinct memory space. Consequently, an instruction may be used to access any of the local, shared, or global memory spaces by specifying an address in the unified memory space.

The L1 Cache 320 in each SPM 310 can be used to cache private per-thread local data and also per-application global data. In some embodiments, the per-CTA shared data may be cached in the L1 cache 320. The LSUs 303 are coupled to a uniform L1 cache 375, the shared memory 306, and the L1 cache 320 via a memory and cache interconnect 380. The uniform L1 cache 375 is configured to receive read-only data and constants from memory via the L1.5 Cache 335.

### Graphics Pipeline Architecture

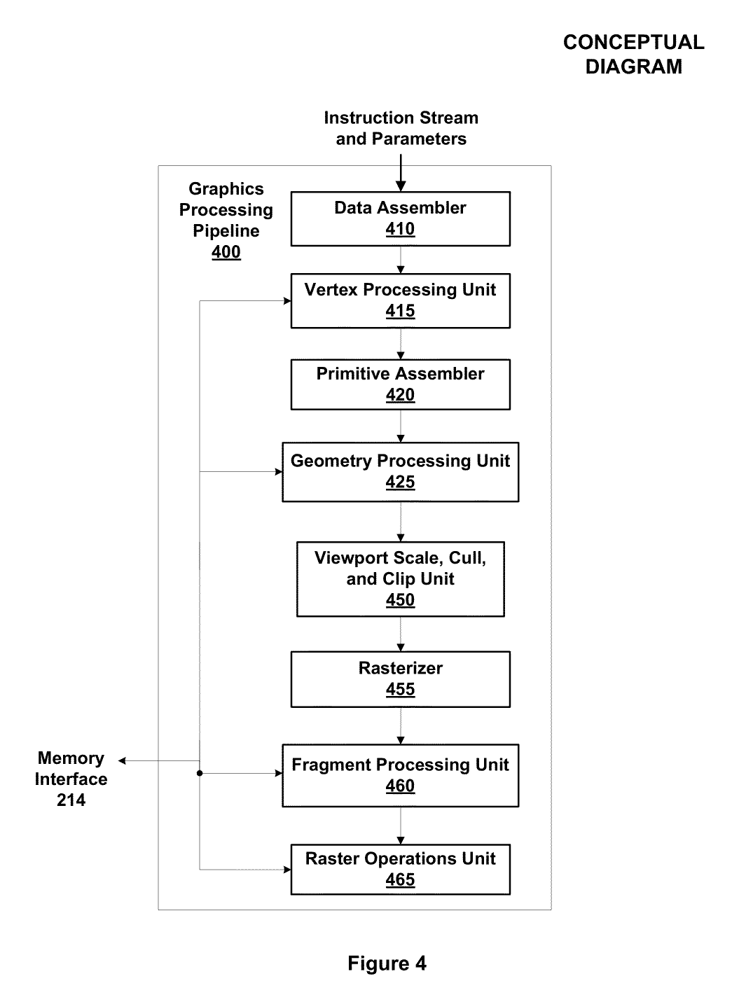

FIG. 4 is a conceptual diagram of a graphics processing pipeline 400, that one or more of the PPUs 202 of FIG. 2 can be configured to implement, according to one embodiment of the present invention. For example, one of the SPMs 310 may be configured to perform the functions of one or more of a vertex processing unit 415, a geometry processing unit 425, and a fragment processing unit 460. The functions of data assembler 410, primitive assembler 420, rasterizer 455, and raster operations unit 465 may also be performed by other processing engines within a GPC 208 and a corresponding partition unit 215. Alternately, graphics processing pipeline 400 may be implemented using dedicated processing units for one or more functions.

Data assembler 410 processing unit collects vertex data for high-order surfaces, primitives, and the like, and outputs the vertex data, including the vertex attributes, to vertex processing unit 415. Vertex processing unit 415 is a programmable execution unit that is configured to execute vertex shader programs, lighting and transforming vertex data as specified by the vertex shader programs. For example, vertex processing unit 415 may be programmed to transform the vertex data from an object-based coordinate representation (object space) to an alternatively based coordinate system such as world space or normalized device coordinates (NDC) space. Vertex processing unit 415 may read data that is stored in L1 cache 320, parallel processing memory 204, or system memory 104 by data assembler 410 for use in processing the vertex data.

Primitive assembler 420 receives vertex attributes from vertex processing unit 415, reading stored vertex attributes, as needed, and constructs graphics primitives for processing by geometry processing unit 425. Graphics primitives include triangles, line segments, points, and the like. Geometry processing unit 425 is a programmable execution unit that is configured to execute geometry shader programs, transforming graphics primitives received from primitive assembler 420 as specified by the geometry shader programs. For example, geometry processing unit 425 may be programmed to subdivide the graphics primitives into one or more new graphics primitives and calculate parameters, such as plane equation coefficients, that are used to rasterize the new graphics primitives.

In some embodiments, geometry processing unit 425 may also add or delete elements in the geometry stream. Geometry processing unit 425 outputs the parameters and vertices specifying new graphics primitives to a viewport scale, cull, and clip unit 450. Geometry processing unit 425 may read data that is stored in parallel processing memory 204 or system memory 104 for use in processing the geometry data. Viewport scale, cull, and clip unit 450 performs clipping, culling, and viewport scaling and outputs processed graphics primitives to a rasterizer 455.

Rasterizer 455 scan converts the new graphics primitives and outputs fragments and coverage data to fragment processing unit 460. Additionally, rasterizer 455 may be configured to perform z culling and other z-based optimizations.

Fragment processing unit 460 is a programmable execution unit that is configured to execute fragment shader programs, transforming fragments received from rasterizer 455, as specified by the fragment shader programs. For example, fragment processing unit 460 may be programmed to perform operations such as perspective correction, texture mapping, shading, blending, and the like, to produce shaded fragments that are output to raster operations unit 465. Fragment processing unit 460 may read data that is stored in parallel processing memory 204 or system memory 104 for use in processing the fragment data. Fragments may be shaded at pixel, sample, or other granularity, depending on the programmed sampling rate.

Raster operations unit 465 is a processing unit that performs raster operations, such as stencil, z test, blending, and the like, and outputs pixel data as processed graphics data for storage in graphics memory. The processed graphics data may be stored in graphics memory, e.g., parallel processing memory 204, and/or system memory 104, for display on display device 110 or for further processing by CPU 102 or parallel processing subsystem 112. In some embodiments of the present invention, raster operations unit 465 is configured to compress z or color data that is written to memory and decompress z or color data that is read from memory.

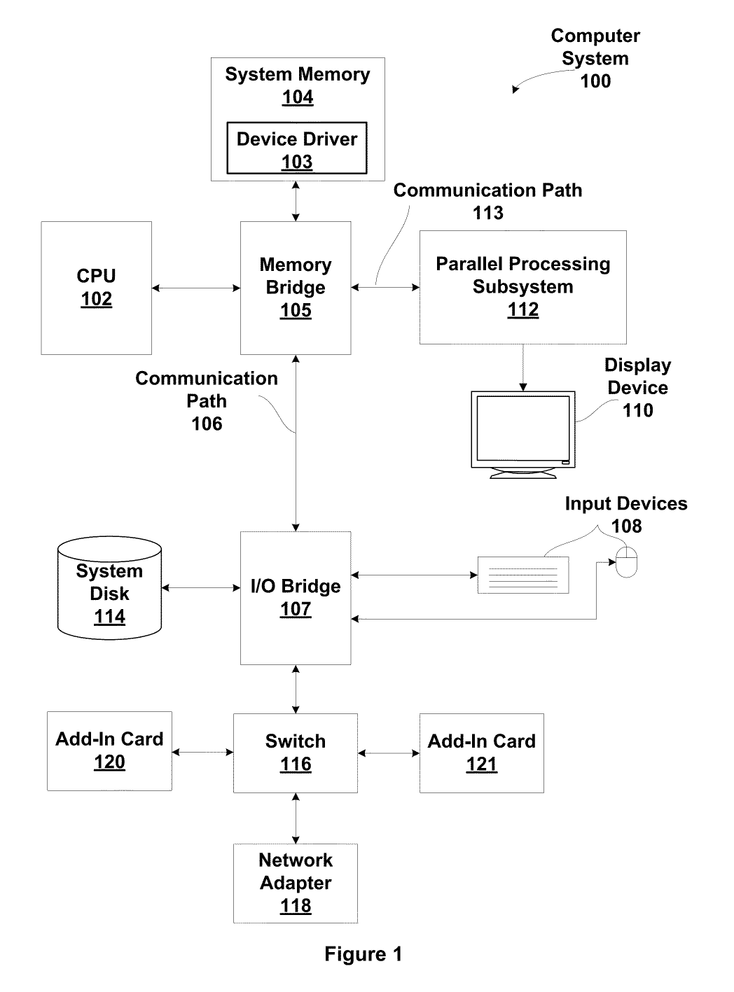

Persons skilled in the art will understand that the architecture described in FIGS. 1, 2, 3A, 3B, 3C, and 4 in no way limits the scope of the present invention and that the techniques taught herein may be implemented on any properly configured processing unit, including, without limitation, one or more CPUs, one or more multi-core CPUs, one or more PPUs 202, one or more GPCs 208, one or more graphics or special purpose processing units, or the like, without departing the scope of the present invention.

In embodiments of the present invention, it is desirable to use PPU 122 or other processor(s) of a computing system to execute general-purpose computations using thread arrays. Each thread in the thread array is assigned a unique thread identifier (“thread ID”) that is accessible to the thread during its execution. The thread ID, which can be defined as a one-dimensional or multi-dimensional numerical value controls various aspects of the thread's processing behavior. For instance, a thread ID may be used to determine which portion of the input data set a thread is to process and/or to determine which portion of an output data set a thread is to produce or write.

A sequence of per-thread instructions may include at least one instruction that defines a cooperative behavior between the representative thread and one or more other threads of the thread array. For example, the sequence of per-thread instructions might include an instruction to suspend execution of operations for the representative thread at a particular point in the sequence until such time as one or more of the other threads reach that particular point, an instruction for the representative thread to store data in a shared memory to which one or more of the other threads have access, an instruction for the representative thread to atomically read and update data stored in a shared memory to which one or more of the other threads have access based on their thread IDs, or the like. The CTA program can also include an instruction to compute an address in the shared memory from which data is to be read, with the address being a function of thread ID. By defining suitable functions and providing synchronization techniques, data can be written to a given location in shared memory by one thread of a CTA and read from that location by a different thread of the same CTA in a predictable manner. Consequently, any desired pattern of data sharing among threads can be supported, and any thread in a CTA can share data with any other thread in the same CTA. The extent, if any, of data sharing among threads of a CTA is determined by the CTA program; thus, it is to be understood that in a particular application that uses CTAs, the threads of a CTA might or might not actually share data with each other, depending on the CTA program, and the terms “CTA” and “thread array” are used synonymously herein.

FIG. 3C is a block diagram of the SPM 310 of FIG. 3A, according to one embodiment of the present invention. The SPM 310 includes an instruction L1 cache 370 that is configured to receive instructions and constants from memory via L1.5 cache 335. A warp scheduler and instruction unit 312 receives instructions and constants from the instruction L1 cache 370 and controls local register file 304 and SPM 310 functional units according to the instructions and constants. The SPM 310 functional units include N exec (execution or processing) units 302 and P load-store units (LSU) 303.

SPM 310 provides on-chip (internal) data storage with different levels of accessibility. Special registers (not shown) are readable but not writeable by LSU 303 and are used to store parameters defining each CTA thread's “position.” In one embodiment, special registers include one register per CTA thread (or per exec unit 302 within SPM 310) that stores a thread ID; each thread ID register is accessible only by a respective one of the exec unit 302. Special registers may also include additional registers, readable by all CTA threads (or by all LSUs 303) that store a CTA identifier, the CTA dimensions, the dimensions of a grid to which the CTA belongs, and an identifier of a grid to which the CTA belongs. Special registers are written during initialization in response to commands received via front end 212 from device driver 103 and do not change during CTA execution.

A parameter memory (not shown) stores runtime parameters (constants) that can be read but not written by any CTA thread (or any LSU 303). In one embodiment, device driver 103 provides parameters to the parameter memory before directing SPM 310 to begin execution of a CTA that uses these parameters. Any CTA thread within any CTA (or any exec unit 302 within SPM 310) can access global memory through a memory interface 214. Portions of global memory may be stored in the L1 cache 320.

Local register file 304 is used by each CTA thread as scratch space; each register is allocated for the exclusive use of one thread, and data in any of local register file 304 is accessible only to the CTA thread to which it is allocated. Local register file 304 can be implemented as a register file that is physically or logically divided into P lanes, each having some number of entries (where each entry might store, e.g., a 32-bit word). One lane is assigned to each of the N exec units 302 and P load-store units LSU 303, and corresponding entries in different lanes can be populated with data for different threads executing the same program to facilitate SIMD execution. Different portions of the lanes can be allocated to different ones of the G concurrent thread groups, so that a given entry in the local register file 304 is accessible only to a particular thread. In one embodiment, certain entries within the local register file 304 are reserved for storing thread identifiers, implementing one of the special registers.

Shared memory 306 is accessible to all CTA threads (within a single CTA); any location in shared memory 306 is accessible to any CTA thread within the same CTA (or to any processing engine within SPM 310). Shared memory 306 can be implemented as a shared register file or shared on-chip cache memory with an interconnect that allows any processing engine to read from or write to any location in the shared memory. In other embodiments, shared state space might map onto a per-CIA region of off-chip memory, and be cached in L1 cache 320. The parameter memory can be implemented as a designated section within the same shared register file or shared cache memory that implements shared memory 306, or as a separate shared register file or on-chip cache memory to which the LSUs 303 have read-only access. In one embodiment, the area that implements the parameter memory is also used to store the CTA ID and grid ID, as well as CTA and grid dimensions, implementing portions of the special registers. Each LSU 303 in SPM 310 is coupled to a unified address mapping unit 352 that converts an address provided for load and store instructions that are specified in a unified memory space into an address in each distinct memory space. Consequently, an instruction may be used to access any of the local, shared, or global memory spaces by specifying an address in the unified memory space.

The L1 Cache 320 in each SPM 310 can be used to cache private per-thread local data and also per-application global data. In some embodiments, the per-CTA shared data may be cached in the L1 cache 320. The LSUs 303 are coupled to a uniform L1 cache 371, the shared memory 306, and the L1 cache 320 via a memory and cache interconnect 380. The uniform L1 cache 371 is configured to receive read-only data and constants from memory via the L1.5 Cache 335.

### A Multi-Grid Fluid Pressure Solver

A visual artifact that researchers and practitioners encounter when simulating fluid movement within a solid boundary is that the liquid appears to crawl on walls and stick to ceilings in an unnatural manner. In the following description the terms sticky (solid) boundary conditions and separating (solid) boundary conditions are used to refer to the enforcement of the normal velocity to be exactly zero and greater than or equal to zero at the solid boundary, respectively. The main reason that researchers in computer graphics have tolerated the visual artifacts associated with sticky boundary conditions is that the introduction of inequality constraints turns the linear system of the discretized Poisson equation into a Linear Complementarity Problem (LCP) which is much more expensive to solve. Instead, as described further herein, the LCP may be solved with a multi-grid method, which allows the three-dimensional simulation of substantially larger models while producing accurate results. Separating solid boundary conditions are enforced for the LCP solution, without introducing difficulty for computing the solution.

The multi-grid is a geometric grid of cubic cells that provides a three-dimensional representation of the fluid to be simulated. A fluid pressure solver that simultaneously solves the LCP for the regular cubic cells may be efficiently executed by a GPU such as the PPU 112 or by another SIMD architecture. Parallel execution is performed to simultaneously compute values for the grid cells, e.g., regular cubic cells. Additionally, a specialized multi-grid algorithm for solving the LCP may be used to accelerate simulations, as described further herein.

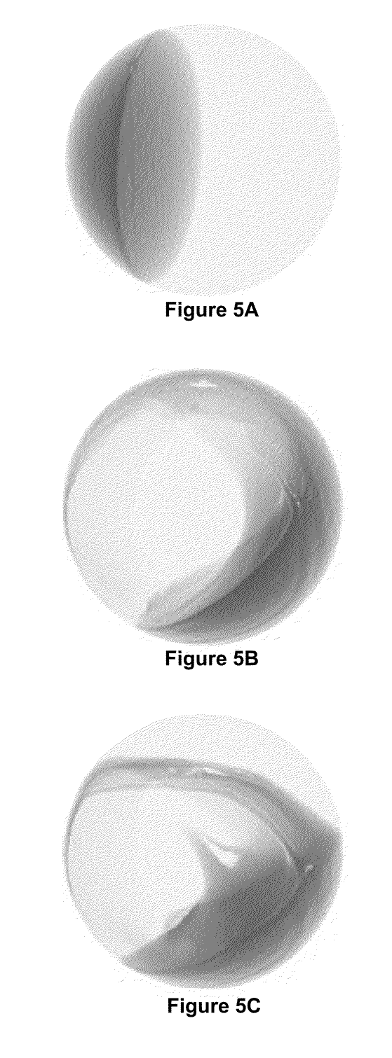

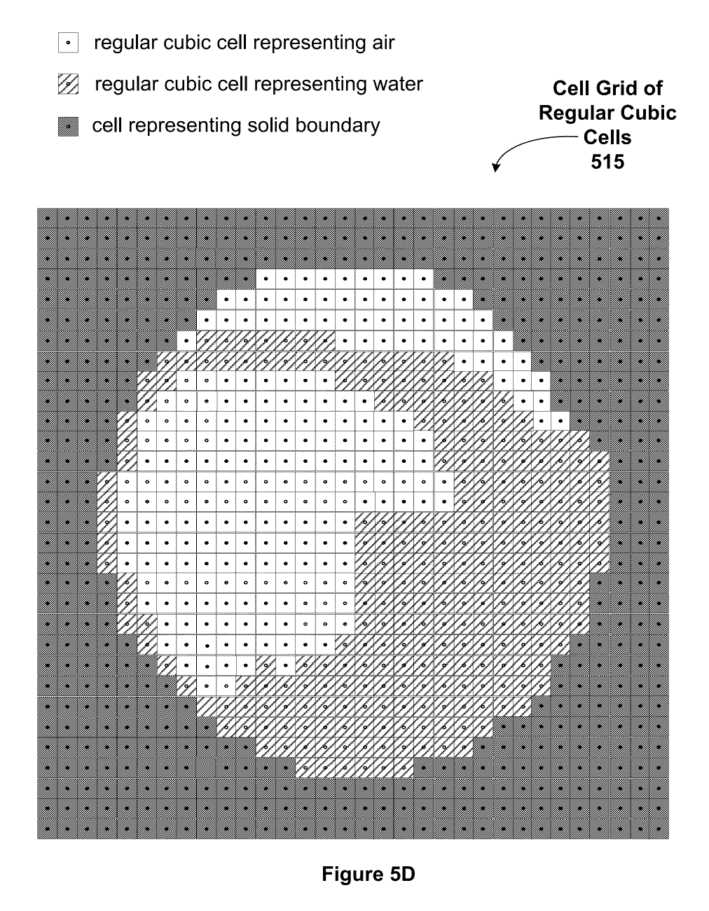

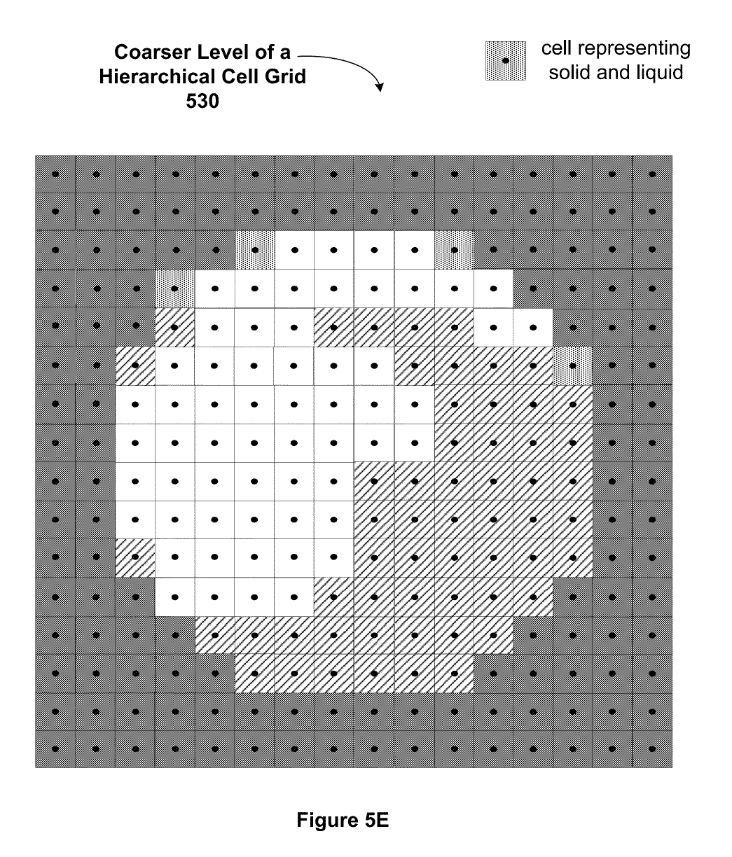

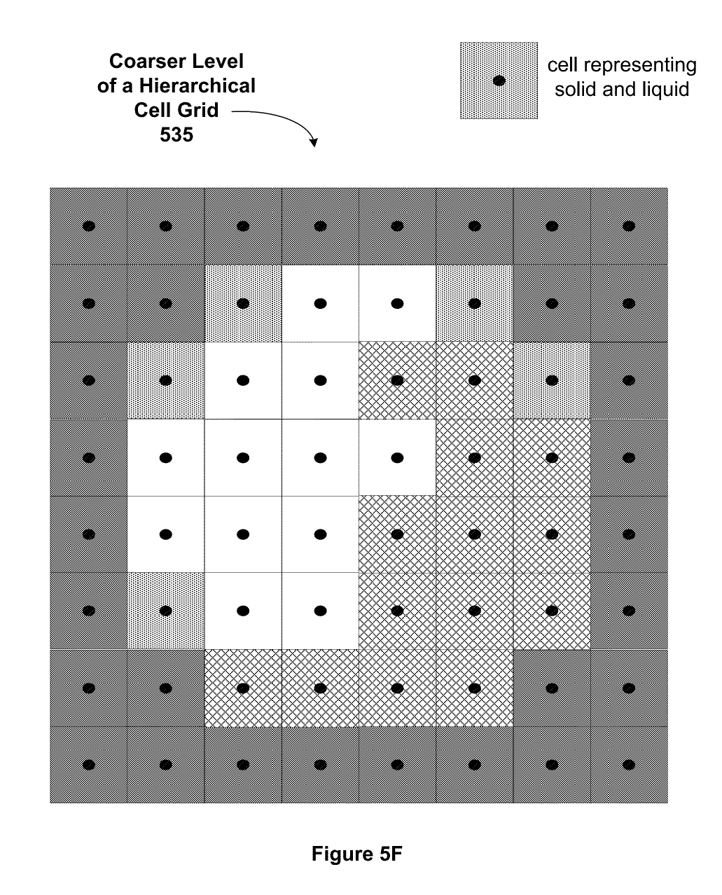

FIG. 5A is an image of an initial condition of liquid in a sphere, where the sphere provides a solid boundary. FIG. 5B is an image of the liquid in the sphere produced using conventional solid boundary condition simulation techniques, according to the prior art. When conventional solid boundary condition simulation techniques are used, the liquid tends to unnaturally stick to the spherical boundary. FIG. 5C is an image of liquid in a sphere produced using separating boundary condition simulation techniques, according to one embodiment of the present invention. Applying separating boundary conditions during simulation causes the liquid to peel off the spherical boundary easily, producing more accurate simulation results and more realistic images.

Fluids are simulated by solving the inviscid Euler Equations,

$$\frac{\partial u}{\partial t} = - ( u \cdot ∇ ) u + \frac{f}{ρ} - \frac{∇ p}{ρ} \qquad equation ( 1 )$$

With Dirichlet and Neumann boundary conditions, subject to the incompressibility constraint

∇·u=0, equation (2)

where u is the fluid velocity field, p is the pressure, t is time, ρ is the fluid density, and f is a field of external forces. The equations are solved in the domain specified by a scalar level-set field φ in the region where φ is non-positive. φ itself is evolved by

$$\frac{\partial ϕ}{\partial t} = - u \cdot ∇ ϕ \qquad equation ( 3 )$$

A regular staggered geometric grid is used to discretize the simulation domain and model the fluid volume that includes the liquid and air within the boundary. The regular staggered geometric grid allows for curved solid boundaries. FIG. 5D is a cross section of the geometric cell grid model comprised of regular cubic cells 515, according to one embodiment of the present invention. The different regular cubic cells represent air, water, and a solid boundary.

The x, y, and z components of fluid velocity u=(u, v, w) are stored at the center of the regular cubic cell faces perpendicular to the x, y, and z axis, respectively. The scalar pressure p and the level set function φ are stored at each regular cubic cell center. u^{s}=(u^{s}, v^{s}, w^{s}) for the solid velocity and V_{i,j,k} for the fraction of non-solid matter, i.e., fluid and air in the regular cubic cell (i, j, k). The scalars V_{i+1/2,j,k}, V_{i,j+1/2,k}, and V_{i,j,k+1/2} represent the fraction of non-solid matter in the overlapping the regular cubic cells along the x, y, and z axes respectively.

Incompressibility, i.e., the divergence free condition, is enforced for the velocity field. The pressure p that enforces the divergence free constraint can be found by minimizing the kinematic energy integrated over the liquid domain. The integration is discretized and the derivative of the energy is set to zero, yielding a linear system of p, where u* denotes the velocity field before incompressibility is enforced.

L(p)_{i,j,k}=D(u*)_{i,j,k} equation (4)

for all cells where φ_{i+1,y,k}<0. The left hand side term L(p)_{i,j,k} is composed of the six components

I_{i+,j,k}+I_{i-,j,k}+I_{i,j+,k}+I_{i,j-,k+}+I_{i,j,k+}+I_{i,j,k-} equation (5)

where

I_{i+,j,k}=V_{i+1/2,j,k}(p_{i,j,k}−p_{i+,j,k}). equation (6)

The pressure values are

equation (7)

The values I_{i-,j,k}, I_{i,j+,k}, I_{i,j-,k}, I_{i,j,k+}, I_{i,j,k-} are defined similarly.

The right hand side is

D(u)_{i,j,k}=d^{x}(u)_{i,j,k}+d^{y}(u)_{i,j,k}+d^{z}(u)_{i,j,k} Equation (8)

where the term d^{x}(u)_{i,j,k} is given by

$$\begin{matrix}\frac{1}{Δ x} ( {V}_{i + \frac{1}{2} , j , k} {u}_{i + \frac{1}{2} , j , k} - {V}_{i - \frac{1}{2} , j , k} {u}_{i - \frac{1}{2} , j , k} ) + & Equation ( 9 ) \\ ( {V}_{i + \frac{1}{2} , j , k} - {V}_{i , j , k} ) {u}_{i + \frac{1}{2} , j , k}^{s} - ( {V}_{i - \frac{1}{2} , j , k} - {V}_{i , j , k} ) {u}_{i + \frac{1}{2} , j , k}^{s} & Equation ( 10 )\end{matrix}$$

The other terms, d^{y}(u)_{i,j,k} and d^{z}(u)_{i,j,k} are defined similarly. The formulation defined by equations 4-10 incorporates the ghost fluid method to enforce p=0 at the surface of the liquid instead of at each grid cell center. φ is extrapolated to regular cubic cells representing solid that are one grid cell away from regular cubic cells representing liquid so that the regular cubic cells representing solid are included as unknowns in the linear system. Moreover, the solid velocity u^{s} also needs to be extrapolated to the faces of nearby regular cubic cells representing liquid.

The system is then subjected to the separating complementarity condition

0≦p⊥(u−v_{solid})·\hat{n}≧0 equation (11)

The separating complementarity condition states that either both p≧0 and (u−v_{solid})·\hat{n}=0 are true or both p=0 and (u−v_{solid})·\hat{n}≧0 are true. After p is determined it is used to make u divergence free. In order to satisfy the complementarity conditions p≧0. In one conventional technique, a PATH solver based on Quadratic Programming (QP) is used to solve the LCP at a high computational cost which limits application of the conventional technique to small 2D domains.

The system may be solved efficiently using a multi-grid method. To show why a multi-grid approach is well suited for solving the linear complementarity problem above, equation (4) is first written in general matrix form without the complementarity condition. For each cell

A_{i,j,k}^{i,j,k}P_{i,j,k}+A_{i,j,k}^{i+1,j,k}P_{i+1,j,k}+A_{i,j,k}^{i-1,j,k}P_{i-1,j,k}+ . . . =b_{i,j,k} Equation (12)

where the A_{i,j,k}'s are the matrix coefficients involving cell (i,j,k). Solving for the unknown pressure at the cell yields

$${p}_{i , j , k} = \frac{1}{{A}_{i , j , k}^{i , j , k}} ( {b}_{i , j , k} - {A}_{i , j , k}^{i + 1 , j , k} {P}_{i + 1 , j , k} - {A}_{i , j , k}^{i - 1 , j , k} {p}_{i + 1 , j , k} - … ) \qquad Equation ( 13 )$$

Such a linear system can be solved efficiently by global methods such as PCG. However, considering the complementarity condition in equation (11) turns the simple equation (13) in each boundary cell into

$${p}_{i , j , k} = max ( 0 , \frac{1}{{A}_{i , j , k}^{i , j , k}} ( \begin{matrix}{b}_{i , j , k} - {A}_{i , j , k}^{i + 1 , j , k} {p}_{i + 1 , j , k} - \\ {A}_{i , j , k}^{i + 1 , j , k} {p}_{i + 1 , j , k} - …\end{matrix} ) ) \qquad Equation ( 14 )$$

While the max operator prevents the system from being solved by PCG, it can easily be solved with a Projected Gauss-Seidel method by applying (14) iteratively. However, projected Gauss-Seidel converges much more slowly than global methods. Fortunately, there is possible to accelerate the convergence by using the projected Gauss-Seidel method as the building block of a multi-grid solver. The basic idea behind the approach is therefore to replace the traditional Red-Black Gauss-Seidel (RGBS) iteration used in the smoothing step of a multi-grid solver with the Projected Red-Black Gauss-Seidel (PRGBS) iteration.

Strictly speaking, the complementarity condition must be enforced precisely at the solid-liquid interface that, in general, is not aligned with the cubic cell boundary. To handle this more general case correctly, all the pressure values p_{i,j,k} around the interface have to be modified simultaneously to satisfy the condition. To enforce this non-aligned complementarity condition, all edges that cross the solid-liquid interface are iterated through and checked if the pressure at the interface is less than zero. For those edges that are less than zero, the end point pressures are adjusted to enforce zero pressure at the interface. The pressure modifications are not unique so, adjustments are made that minimize the sum of the squared magnitude of the changes.

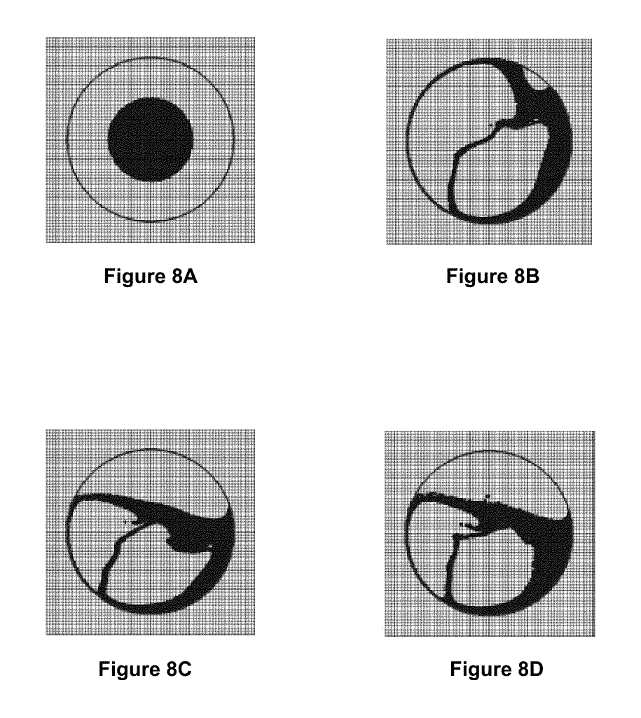

In practice, the simpler method of enforcing p≧0 at the center of solid cells next to liquid cells produces results that are hardly distinguishable from results generated with the more complicated method of enforcing zero pressure at the interface. FIGS. 8C and 8D show comparisons of the two methods. As the results show, the simpler method yields convincing wall separation behavior even in the presence of curved boundaries. Therefore, the simpler method is used in the following description because the multi-grid implementation is simplified considerably.

### Generating a Multi-Grid that is Used by a Fluid Pressure Solver

FIGS. 5E and 5F illustrate coarser hierarchical levels of the multi-grid for the geometric cell grid 515 shown in FIG. 5D, according to one embodiment of the present invention. FIG. 5E is a cross section of a first coarser hierarchical level of the geometric cell grid 530 that is a coarser level of the geometric cell grid 515 shown in FIG. 5D, according to one embodiment of the present invention. FIG. 5F is a cross section of a second coarser hierarchical level of the geometric cell grid 535 that is a coarser level of the geometric cell grid 515 shown in FIG. 5D, according to one embodiment of the present invention. The coarser levels of the multi-grid include regular cubic cells that represent a combination of solid and liquid (water).

The multi-grid provides a hierarchy of increasingly coarser representations of the model that may be used by a fluid pressure solver. As previously explained, Eulerian simulation techniques in which the complementarity condition is applied require solving the LCP to determine pressure values for each cell within the cell grid. Different levels of the multi-grid are used to compute the pressure values for different regions of the model, maintaining accuracy while simplifying the computations. The multi-grid ensures that air bubbles are correctly modeled near the surface of the water so that details of the water movement are retained.

The number of levels of a multi-grid is determined by M=log₂ min(Bₓ, B_{y}, B_{z}), where Bₓ, B_{y}, and B_{z} are the number of regular cubic cells along the x, y, and z axes, respectively. The finest level of the multi-grid corresponds to the geometric cell grid with Δx^{M}=Δx and u_{i,j,k}^{M}=u_{i,j,k}.

The velocities in the hierarchy of the multi-grid are evaluated by sweeping down then sweeping up the hierarchy. On the finest level M, the velocity of a cell is declared to be known if the cell is a liquid cell or if the velocity is already extrapolated. Then the levels are traversed from finest to coarsest and velocities are computed by trilinearly interpolating the velocities of the previous level using only known velocities and renormalizing the interpolation weights accordingly. The velocity of a coarse cell is declared to be known if at least one corresponding finer cell velocity is known. The hierarchy of the cell grid is then traversed in the reverse order, from coarsest to finest, and velocities on finer levels are evaluated by trilinearly interpolating values from coarser levels of the hierarchical cell grid. After the two traversals are complete, every cell of the finest grid has a known velocity.

TABLE 1 summarizes the algorithm for a multi-grid pressure solver that is configured to handle the discretization of the Poisson equation subject to separating solid boundary conditions.

TABLE 1
Multi-Grid Pressure Solver

1: for m=M−1 down to 1 do
2: Down sample φ^{m+1} → φ^{m} and V^{m+1} → V^{m}
3: end for
4: for m=M down to 1 do
5: Extrapolate φ^{m} to solid cells that are one cell away from liquid
6: Compute matrix A^{m} for level m using equation (4)
7: end for
8: b^{M} = D(u)
9: p^{M} = 0
10: Compute pₘᵢₙ^{M}
11: for i=1 to num_Full_Cycles do
12: Full_Cycle( )
13: end for
14: for i=1 to num_V_Cycles do
15: V_Cycle(M)
16: end for

Each coarse grid is derived from the previous finer grid by collapsing eight cells into one. As previously explained, at each level of the hierarchical grid, a linear system of the form A^{m}p^{m}=b^{m} has to be solved. To down sample Vⁿ⁺¹ to V^{m}, an 8-to-1 average is computed.

$$\begin{matrix}{v}_{i , j , k}^{m} = \frac{1}{8} ( {v}_{2 i , 2 j , 2 k}^{m + 1} + {v}_{2 i + 1 , 2 j , 2 k}^{m + 1} + {v}_{2 i , 2 J + 1 , 2 k}^{m + 1} + {v}_{2 i + 1 , 2 j + 1 , 2 k}^{m + 1} + & Equation ( 15 ) \\ {v}_{2 i , 2 k , 2 j + 1}^{m + 1} + {v}_{2 i + 1 , 2 j , 2 k + 1}^{m + 1} + {v}_{2 i , 2 j + 1 , 2 k + 1}^{m + 1} + {v}_{2 i + 1 , 2 j + 1 , 2 k + 1}^{m + 1} & Equation ( 16 )\end{matrix}$$

Where i, j, k can be half indices for faces. If a required value lies outside the simulation grid, the border value is used instead.

For down sampling φ^{m+1} to φ^{m} the following two cases are identified:

1. if the 8 φ-values all have the same sign or I<M-C use the 8-to-1 average,

2. otherwise use the average of the positive φ-values.

The key idea is to ensure that air bubbles persist in the C finest levels. In the C finest levels, bubbles have a significant influence on the resulting pressure values. On the other hand, letting air bubbles disappear in coarser levels is not problematic because only a general pressure profile is needed in the coarser levels in order to get accurate pressure values in the original grid. Tracking bubbles on coarser levels is not only unnecessary but keeping bubbles at the coarser levels yields incorrect profiles because the influence of the bubbles at the coarser levels becomes exaggerated. In one embodiment, C=2 is used for simulations.

The coefficients of the A^{m} matrix are then computed for each level of the multi-grid using Equation (4). Unlike conventional solvers, sub-grid features are handled correctly through the ghost fluid and solid fraction methods on all the levels of the hierarchy. Therefore, in contrast with conventional solvers, the solver converges even in the presence of irregular free-surface and solid boundaries. Handling sub-grid features correctly is crucial to obtain meaningful pressures fields on coarse levels.

For smoothing, the Projected Red-Black Gauss-Seidel (RBGS) method may be used and the system may be solved in two parallel passes. A projection step is performed after the two parallel passes to enforce separating solid boundary conditions. The projection ensures that the pressure of each cell is greater than or equal to

$${p}_{min i , j , k}^{M} = \{ \begin{matrix}0 & if i . j . k is inside a solid \\ - ∞ & otherwise\end{matrix} \qquad equation ( 17 )$$

For prolongation tri-linear interpolation is used.

TABLE 2 summarizes the algorithm for the V_Cycle function shown in line 15 of TABLE 1.

TABLE 2
V_Cycle function

1: if m ==1 then
2: Solve the linear system, A¹p¹ = b¹
3: else
4: for i=1 to num_Pre_Sweep do
5: Smooth(p^{m}) and enforce pₘᵢₙ^{m} (PRBGS)
6: end for
7: r^{m} = b^{m -} Ap^{m}
8: b^{m-1} = Restrict(r^{m})
9: p^{m-1}= 0
10: if m > M-S then
11: pₘᵢₙ^{m-1} = DownsampleSubtract(pₘᵢₙ^{m},p^{m})
12: else
13: pₘᵢₙ^{m} = ⁻∞
14: end if
15: V_Cycle(m−1)
16: p^{m}= p^{m}+ Prolong(p^{m-1})
17: for i=1 to num_Post_Sweep do
18: Smooth(p^{m}) and enforce pₘᵢₙ^{m} (PRBGS)
19: end for
20: end if

TABLE 3 summarizes the algorithm for the Full_Cycle function shown in line 12 of TABLE 2.

TABLE 3
Full_Cycle function

1: p^{tmp} = p^{M}
2: Compute pₘᵢₙ^{M}
3: pₘᵢₙ^{M} − = p^{M}
4: r^{M} = b^{M} − Ap^{M}
5: for m=M − 1 down to 1 do
6: r^{m} = Restrict(r^{m+1})
7: if m > M-S then
8: pₘᵢₙ^{m} = DownsampleSubtract(pₘᵢₙ^{m+1},0)
9: else
10: pₘᵢₙ^{m} = ⁻∞
11: end if
12: end for
13: b¹ = r¹
14: Solve the linear system, A¹p¹ = b¹
15: for m=2 to M do
16: p^{m}= Prolong(p^{m-1})
17: b^{m} = r^{m}
18: V_Cycle(m)
19: end for
20: p^{M}= p^{tmp}+ p^{M}

The steps performed in lines 5 and 18 shown in TABLE 2 involve the minimum pressure pₘᵢₙ^{M} and are not used in other multi-grid pressure solvers. When smoothing, i.e., executing Gauss-Seidel iterations, pₘᵢₙ^{M} is enforced. More precisely,

p_{i,j,k}^{m}=max(p_{i,j,k}^{m},p_{min i,j,k}^{m}) Equation (18)

Equation (18) enforces the separating solid boundary condition. The steps performed in line 11 of TABLE 2 and line 8 of TABLE 3 perform an essential downsampling operation that transfers the separating boundary constraints from fine to coarser levels of the multi-grid, taking the current pressure estimate into account. The downsampleSubtract operation is defined as

DownsampleSubtract(pₘᵢₙ^{m},p^{m})_{i,j,k}= Equation (19)

max_{a,b,cε(0,1)}(p_{min 2i+a,2j+b,2k+c}^{m}−p_{2i+a,2j+b,2k+c}^{m}) Equation (20)

The downsampleSubtract operation is only executed on the S finest levels of the multi-grid because the separating boundary condition is not meaningful in coarser levels of the multi-grid. In one embodiment, S=3.

In one embodiment the liquid surface is tracked using a particle based approach. When a grid based approach is used φ should be carefully extrapolated into solids for the method to work properly. For a solid cell next to a liquid cell whose pressure is zero, φ should be set to the positive distance to the solid surface, not the negative value extrapolated from the liquid. The condition is based on the normal relative velocity. Only with this modification does the liquid peel-off freely from solids.

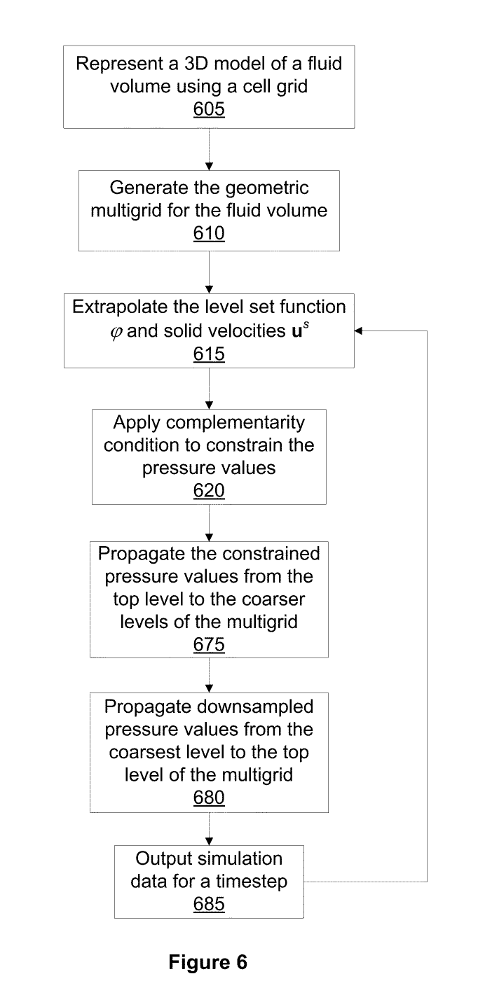

FIG. 6 is a flow diagram illustrating a technique for performing a simulation that applies separating boundary conditions to a multi-grid model of a fluid volume, according to one embodiment of the present invention. Although the method steps are described in conjunction with the systems of FIGS. 1, 2, 3A, 3B, 3C, and 4 persons skilled in the art will understand that any system configured to perform the method steps, in any order, is within the scope of the inventions.

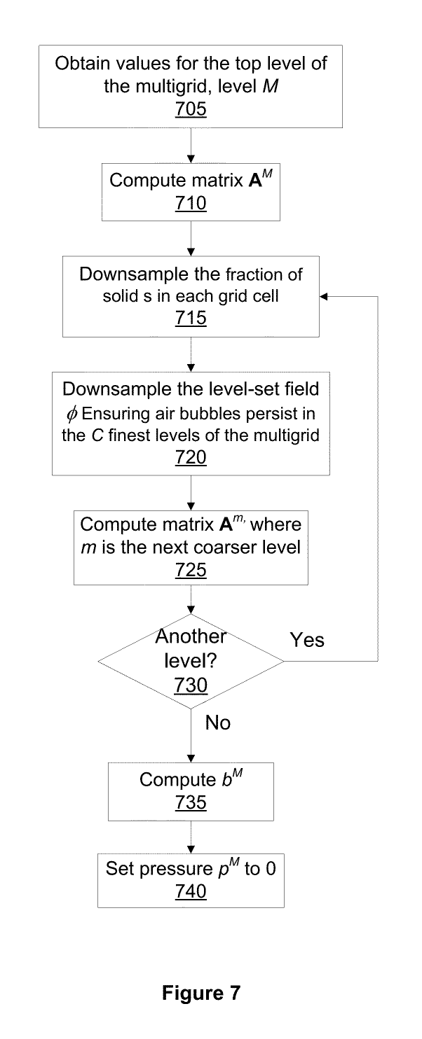

The steps shown in FIG. 6 are performed by a processor, e.g., CPU or GPU, for one or more timesteps, to complete a simulation of a 3D model of a fluid volume. A frame of data is generated for each timestep to produce images for display. At step 605 a 3D model of the fluid volume is represented using a three-dimensional grid of one or more regular cubic cells. At step 610 a geometric multi-grid is generated for the fluid volume based on the cell grid received at step 605. A technique that may be used to generate the geometric multi-grid is described in conjunction with FIG. 7. The geometric multi-grid comprises first level-set field values associated with a first three-dimensional grid of regular cubic cells (the cell grid obtained at step 605) and second level-set field values associated with a second three-dimensional grid of regular cubic cells that are coarser than the first three-dimensional grid of regular cubic cells. Additional levels of the multi-grid may also be generated, where each successive lower level is coarser than the previous level.

At step 615, the level set function φ is extrapolated to regular cubic cells representing solid that are one grid cell away from regular cubic cells representing liquid and the solid velocity u^{s} is extrapolated to the faces of nearby regular cubic cells representing liquid. At step 620, a separating complementarity condition is applied to constrain pressure values for the first three-dimensional grid, i.e., the finest (top) level of the multi-grid. At step 675, the constrained pressure values are propagated from the top level (M) to each successive coarser level of the multi-grid to the coarsest level (1) to produce downsampled pressure values using the downsampleSubtract operation.

At step 680, the downsampled pressure values are propagated from the coarsest level of the geometric multi-grid, successively to each finer level of the multi-grid until the top level of the multi-grid is reached, to produce updated pressure values for the multi-grid. At step 685, a frame of data corresponding to the three-dimensional model of the fluid volume is generated based on the updated pressure values and the downsampled pressure values. Steps 615 through 685 are repeated for each timestep of the simulation.

FIG. 7 a flowchart illustrating a technique for constructing a multi-grid for use by a multi-grid fluid pressure solver, according to one embodiment of the present invention. Although the method steps are described in conjunction with the systems of FIGS. 1, 2, 3A, 3B, 3C, and 4, persons skilled in the art will understand that any system configured to perform the method steps, in any order, is within the scope of the inventions.

At step 705, a first level-set field values (φ) and first solid fraction values (V) for a three-dimensional model of a fluid volume represented as a first three-dimensional geometric grid from which a multi-grid is generated. The first three-dimensional geometric grid is the highest resolution of the multi-grid, level M.

At step 710, coefficients of the matrix A^{M} are computed using equation (4). At step 715, the first solid fraction values are downsampled to generate second solid fraction values for the second three-dimensional geometric grid. At step 720, the first level-set field values are downsampled to generate second level-set field values for a second three-dimensional geometric grid that represents the three-dimensional model of the fluid volume and is coarser than the first three-dimensional geometric grid.

When C≧1, the downsampling increases the likelihood that air bubbles will persist in the second three-dimensional grid of regular cubic cells. As previously described, different downsampling computations are used based on C and whether the level-set field values to be downsampled to produce a single value for a coarser level of the multi-grid have the same sign. When all of the level-set field values to be downsampled have the same sign, a level-set field value for the second three-dimensional grid of regular cubic cells is computed as an average of a sub-set of the first level-set field values for the first three-dimensional grid of regular cubic cells. When the level of the multi-grid to be generated, m is less than M-C, a level-set field value for the second three-dimensional grid of regular cubic cells is also computed as an average of a sub-set of the first level-set field values for the first three-dimensional grid of regular cubic cells. When m is not less than M-C or all of the level-set field values to be downsampled do not have the same sign, the second three-dimensional grid of regular cubic cells is computed as an average of portion of a sub-set of the second level-set field values having positive signs.

At step 725, coefficients of the matrix A^{m} are computed using equation (4), where I is the next coarser level of the multi-grid, e.g., m=M−1, m=M−2 . . . to m=0. At step 730, the multi-grid generator determines if another level of the multi-grid can be generated, i.e., if m>0. If another level can be generated, then the multi-grid generator returns to step 715. Otherwise, at step 735, the multi-grid generator has completed generating the multi-grid and the multi-grid pressure solver computes b^{M}. At step 740 the multi-grid pressure solver sets the pressure p^{M} to zero. Following step 740, The multi-grid fluid pressure solver algorithm described in conjunction with FIG. 6 may be performed beginning at step 615.

FIG. 8A is an image of an initial condition of liquid in a circle that is moving diagonally to the right and upwards, where the circle provides a solid boundary. FIG. 8B is an image of the liquid in the circuit produced using conventional solid boundary condition simulation techniques, according to the prior art. When conventional solid boundary condition simulation techniques are used, the liquid tends to unnaturally stick to the circular boundary. FIG. 8C is an image of liquid in a circle produced using separating boundary condition simulation techniques with the separating boundary conditions are enforced at the centers of the cubic cells, according to one embodiment of the present invention. FIG. 8D is an image of liquid in a circle produced using separating boundary condition simulation techniques with the separating boundary conditions are enforced at the interface between the solid and liquid, according to one embodiment of the present invention. Applying separating boundary conditions at either the center of cubic cells or the interface during simulation allows the liquid to peel off the circular boundary easily, producing more accurate simulation results and more realistic images.

In sum, a three-dimensional model of water is represented as geometric multi-grid of regular cubic cells. The geometric multi-grid is generated by downsampling a highest resolution of the grid of regular cubic cells to produce successively coarser versions of the fluid model. The geometric multi-grid enables accurate simulations of three dimensional (3D) fluid volumes when the pressure values that are computed are constrained by separating solid boundary conditions at the interface between liquid and a bounding solid. A result of discretizing the Poisson equation, subject to separating solid boundary conditions, is that the simulation requires solving an LCP.

One advantage of the disclosed technique is that the geometric multi-grid is used to efficiently solve the LCP while computing accurate pressure values. Therefore, fluid simulations having solid boundary conditions may be performed with fewer visual artifacts. Additionally, the technique used to solve the LCP is less computationally complex compared with conventional techniques.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

What is claimed is:

1. A method for performing fluid simulations, comprising:
obtaining a geometric multi-grid representing a three-dimensional model of a fluid volume, wherein the geometric multi-grid comprises first level-set field values associated with a first three-dimensional grid of regular cubic cells and second level-set field values associated with a second three-dimensional grid of regular cubic cells that are coarser than the first three-dimensional grid of regular cubic cells;
applying a separating complementarity condition to constrain pressure values for the first three-dimensional grid;
propagating the pressure values from the first level of the geometric multi-grid to a coarsest level of the geometric multi-grid to produce downsampled pressure values;
propagating the downsampled pressure values from the coarsest level of the geometric multi-grid to the first level of the multi-grid to produce updated pressure values; and
generating a frame of data corresponding to the three-dimensional model of the fluid volume based on the updated pressure values and the downsampled pressure values.

2. The method of claim 1, wherein obtaining the geometric multi-grid comprises:
downsampling the first level-set field values to generate the second level-set field values; and
downsampling the second level-set field values to generate third level-set field values associated with a third three-dimensional grid that is coarser than both the first three-dimensional grid and the second three-dimensional grid.

3. The method of claim 2, wherein downsampling the first level-set field values increases the likelihood that air bubbles will persist in the second three-dimensional grid, and downsampling the second-level-set field values increases the likelihood that air bubbles will not persist in the third three-dimensional grid.

4. The method of claim 2, wherein downsampling the first level-set field values comprises computing a level-set field value for the second three-dimensional grid that is an average of a sub-set of the first level-set field values associated with the first three-dimensional grid.

5. The method of claim 2, wherein downsampling the second level-set field values comprises computing a level-set field value for the third three-dimensional grid that is an average of a sub-set of the third level-set field values associated with the first three-dimensional grid when all of the third level-set field values in the sub-set have the same sign.

6. The method of claim 2, wherein downsampling the second level-set field values comprises computing a level-set field value for the third three-dimensional grid that is an average of portion of a sub-set of the third level-set field values associated with the first three-dimensional grid when all third level-set field values in the sub-set do not have the same sign, and wherein each level-set field value in the portion of the sub-set has a position sign.

7. The method of claim 1, wherein applying a separating complementarity condition comprises assigning one or more negative pressures to regular cubic cells that represent a solid such that pressure values on a surface between the solid and a liquid represented by the first three-dimensional grid equal zero.

8. The method of claim 1, wherein applying a separating complementarity condition comprises enforcing a positive pressure value at a center of each regular cubic cell that represents a solid and is adjacent to a regular cubic cell that represents a liquid in the first three-dimensional grid.

9. The method of claim 1, further comprising
obtaining first solid fraction values for the first three-dimensional grid, wherein each solid fraction value indicates a portion of a regular cubic cell that represents a solid; and
downsampling the first solid fraction values to generate second solid fraction values for the second three-dimensional grid.

10. A non-transitory computer-readable storage medium storing instructions that, when executed by a processor, cause the processor to simulate a fluid by performing the steps of:
obtaining a geometric multi-grid representing a three-dimensional model of a fluid volume, wherein the geometric multi-grid comprises first level-set field values associated with a first three-dimensional grid of regular cubic cells and second level-set field values associated with a second three-dimensional grid of regular cubic cells that are coarser than the first three-dimensional grid of regular cubic cells;
applying a separating complementarity condition to constrain pressure values for the first three-dimensional grid;
propagating the pressure values from the first level of the geometric multi-grid to a coarsest level of the geometric multi-grid to produce downsampled pressure values;
propagating the downsampled pressure values from the coarsest level of the geometric multi-grid to the first level of the multi-grid to produce updated pressure values; and
generating a frame of data corresponding to the three-dimensional model of the fluid volume based on the updated pressure values and the downsampled pressure values.

11. The non-transitory computer-readable storage medium of claim 10, wherein obtaining the geometric multi-grid comprises:
downsampling the first level-set field values to generate the second level-set field values; and
downsampling the second level-set field values to generate third level-set field values associated with a third three-dimensional grid that is coarser than both the first three-dimensional grid and the second three-dimensional grid.

12. The non-transitory computer-readable storage medium of claim 11, wherein downsampling the first level-set field values increases the likelihood that air bubbles will persist in the second three-dimensional grid, and downsampling the second-level-set field values increases the likelihood that air bubbles will not persist in the third three-dimensional grid.

13. The non-transitory computer-readable storage medium of claim 11, wherein downsampling the first level-set field values comprises computing a level-set field value for the second three-dimensional grid that is an average of a sub-set of the first level-set field values associated with the first three-dimensional grid.

14. The non-transitory computer-readable storage medium of claim 11, wherein downsampling the second level-set field values comprises computing a level-set field value for the third three-dimensional grid that is an average of a sub-set of the third level-set field values associated with the first three-dimensional grid when all of the third level-set field values in the sub-set have the same sign.

15. The non-transitory computer-readable storage medium of claim 11, wherein downsampling the second level-set field values comprises computing a level-set field value for the third three-dimensional grid that is an average of portion of a sub-set of the third level-set field values associated with the first three-dimensional grid when all third level-set field values in the sub-set do not have the same sign, and wherein each level-set field value in the portion of the sub-set has a position sign.

16. The non-transitory computer-readable storage medium of claim 10, wherein applying a separating complementarity condition comprises assigning one or more negative pressures to regular cubic cells that represent a solid such that pressure values on a surface between the solid and a liquid represented by the first three-dimensional grid equal zero.

17. The non-transitory computer-readable storage medium of claim 10, wherein applying a separating complementarity condition comprises enforcing a positive pressure value at a center of each regular cubic cell that represents a solid and is adjacent to a regular cubic cell that represents a liquid in the first three-dimensional grid.

18. The non-transitory computer-readable storage medium of claim 10, further comprising
obtaining first solid fraction values for the first three-dimensional grid, wherein each solid fraction value indicates a portion of a regular cubic cell that represents a solid; and downsampling the first solid fraction values to generate second solid fraction values for the second three-dimensional grid.

19. A system for performing fluid simulations, the system comprising:
a processor; and
a memory coupled to the processor, wherein the memory includes:
a program including instructions that, when executed by the processor, cause the processor to:
obtain a geometric multi-grid representing a three-dimensional model of a fluid volume, wherein the geometric multi-grid comprises first level-set field values associated with a first three-dimensional grid of regular cubic cells and second level-set field values associated with a second three-dimensional grid of regular cubic cells that are coarser than the first three-dimensional grid of regular cubic cells;
apply a separating complementarity condition to constrain pressure values for the first three-dimensional grid;
propagate the pressure values from the first level of the geometric multi-grid to a coarsest level of the geometric multi-grid to produce downsampled pressure values;
propagate the downsampled pressure values from the coarsest level of the geometric multi-grid to the first level of the multi-grid to produce updated pressure values; and
generate a frame of data corresponding to the three-dimensional model of the fluid volume based on the updated pressure values and the downsampled pressure values.
